(19) United States
(12) Patent Application Publication
(10) Pub. No.: US 2009/0083134 A1
(43) Pub. Date: Mar. 26, 2009

(54) Adaptive Advertising Based On Social Networking Preferences

(76) Inventors: Erik J. Burckart, Raleigh, NC (US); Andrew Ivory, Wake Forest, NC (US); Aaron K. Shook, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/858,378

(22) Filed: Sep. 20, 2007

(51) Int. Cl. G06Q 30/00

(52) U.S. Cl. 705/14

(57) ABSTRACT

A method of providing targeted advertising includes an electronic commerce site that receives a request from a user for a webpage. The electronic commerce site determines an identifier, such as email address, for the user. The electronic commerce site encodes the identifier in a request, such as a universal resource locater (URL), associated with an advertisement. The electronic commerce site embeds the advertisement in the requested webpage and sends the webpage to the user. When an advertising service receives the URL from the user, the advertising service sends a query to a social networking site. The query includes the identifier. Upon receiving preference information for the user from the social networking site in response to query, the advertising service uses the preference information to determine products of interest to the user. The advertising service sends a webpage to the user. The webpage from the advertising service includes information on the products of interest.

### BACKGROUND OF THE INVENTION

1. Technical Field

The present invention relates generally to the field of electronic commerce, and more particularly to a method of and system for providing targeted advertising based upon social networking site preferences.

2. Description of the Related Art

Advertising services constantly strive to provide the best-targeted, most efficient method of getting their advertisements to the right consumers. However, most of the time, advertising services have no idea who the customer is. Without being explicitly told by the consumer, the advertising services have no idea what the consumer likes or dislikes. Some search services attempt to use information such as search terms that the consumer has used in order to determine goods or services that may interest the consumer. However, such use of search terms still may not provide a clear picture of the consumer's interests.

### SUMMARY OF THE INVENTION

The present invention provides a method of and a system for providing targeted advertising. An embodiment of an electronic commerce site of the present invention receives a request from a user for a webpage. The electronic commerce site determines an identifier, such as email address, for the user. The electronic commerce site encodes the identifier in a request, such as a universal resource locater (URL), associated with an advertisement. The electronic commerce site embeds the advertisement in the webpage and sends the webpage to the user.

When an embodiment of an advertising service according to the present invention receives the URL from the user, the advertising service sends a query to a social networking site. The query includes the identifier. Upon receiving preference information for the user from the social networking site in response to query, the advertising service uses the preference information to determine products of interest to the user. The advertising service sends a webpage to the user. The webpage from the advertising service includes information on the products of interest.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 illustrates an embodiment of a webpage according to the present invention; and,

FIG. 3 is a flow diagram of an embodiment of the present invention.

### DETAILED DESCRIPTION OF THE PREFERRED EMBODIMENT

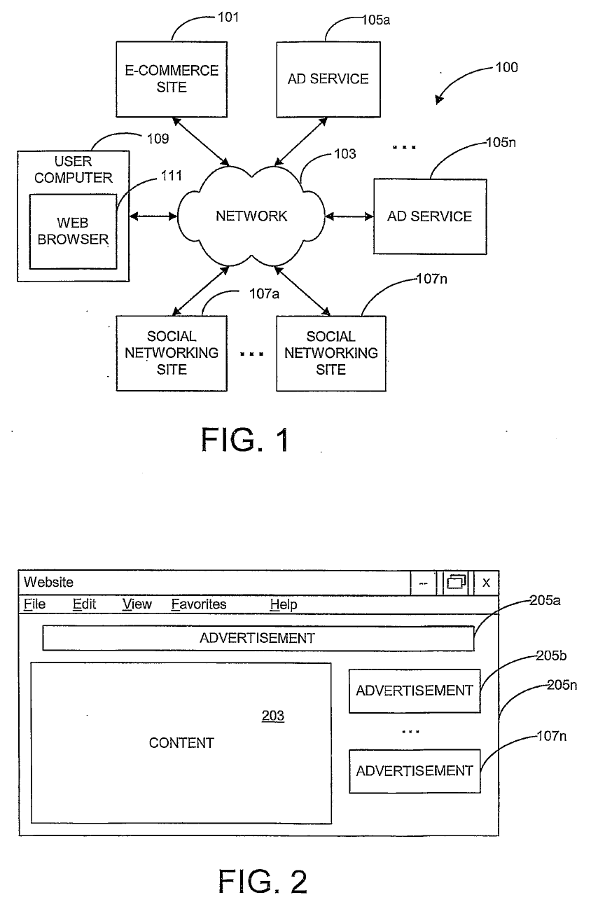

Referring now to the drawings, and first to FIG. 1, a system according to the present invention is designated generally by the numeral 100. System 100 includes an electronic commerce site 101. E-commerce site 101 is connected to a network indicated generally at 103, which preferably as the Internet. E-commerce site 101 typically comprises one or more web server computers. E-commerce site 101 may include any website that includes advertisements or other indicia that link to sites that sell goods or services. Examples of e-commerce sites include search engine sites, such as Google.com, news service sites, such NYTimes.com, and virtually any other site accessible on the Internet. Most Websites provide free content but depend on advertisements embedded in the Web pages they serve for revenue. Accordingly, most Websites are E-commerce sites.

System 100 includes one or more advertising services 105 coupled to network 103. Advertising services 105 are operated by sellers of products, including goods and services. Advertising services 105 may be reached by following hypertext links embedded in advertisements or other indicia displayed in web pages served by e-commerce site 101. Virtually any business or other seller of goods or services may operate an advertising service 105. Advertising services 105 typically comprise one or more Web server computers.

System 100 also includes one or more social networking sites 107 coupled to network 103. Social networking sites 107 provide a means by which members can list information about themselves, such as their pictures, hobbies, interests, tastes, and the like, and meet or communicate with individuals having similar interests. Examples of social networking sites include MySpace and Facebook. Social networking sites 107 typically comprise one or more Web server computers.

System 100 includes a user computer 109 coupled to network 103. User computer 109 may be any computing device, such as a personal computer, a notebook computer, a personal digital assistant (PDA), a cellular telephone, or the like. User computer 109 includes a web browser 111 that enables a user to view and interact with web pages served by sites such as e-commerce site 101, advertising service sites 105, and social networking sites 107.

FIG. 2 illustrates the typical form of a webpage 201. Webpage 201 includes content indicated generally at 203 and one or more advertisements 205. Advertisements 205 may comprise banner ads, sponsored links, pop-ups, and other advertising indicia. Advertisements 205 typically include text and graphics. Advertisements 205 may also include sound, animation, or video content. In accordance with embodiments of the present invention, advertisements 205 include embedded, typically invisible, hypertext links to advertising services 105.

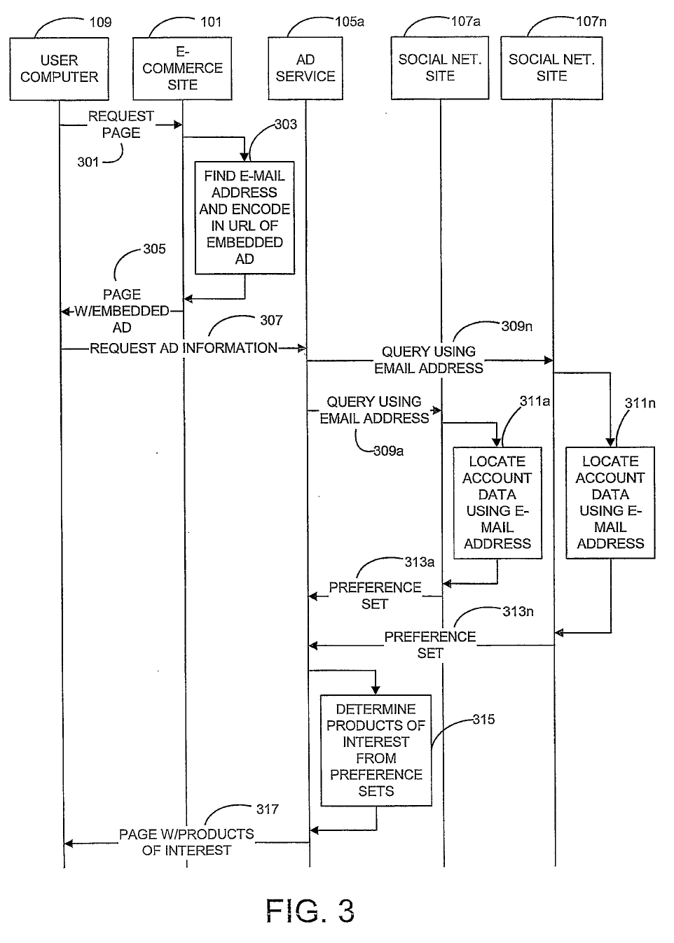

FIG. 3 is a flow diagram of an embodiment of processing according to the present invention. User computer 109 requests a web page, as indicated at 301, from e-commerce site 101. User computer 109 may request the page based upon an entered uniform resource locator (URL), or by following a hypertext link displayed or embedded in another webpage. As indicated at block 303, e-commerce site 101 finds the e-mail address of the user associated with user computer 109 and encodes the e-mail address in the URL of an embedded advertisement. E-commerce site 101 may have found the e-mail address of the user by embedding a cookie in user computer 109 or by some other means. E-commerce site 101 may encode the e-mail address in the URL of each embedded advertisement in the page requested by user computer 109. E-commerce site 101 then sends a webpage with the embedded advertisement or advertisements to user computer 109, as indicated at 305.

The user of user computer 109 may, as indicated at 307, request advertised information from advertising service 105a by clicking on an advertisement embedded in the webpage served at 305. The request from user 109, which is in the form of a URL, includes the e-mail address associated with the user of user computer 109. Advertising service 105 sends queries, as indicated at 309, to one or more social networking sites 107. The queries include the e-mail address of the user. The user may or may not be a member of one or any of the social networking sites. However, as indicated at blocks 311, social networking sites 107 attempt to locate account data for the user using the e-mail address of inquiry. If any of social networking sites 107 have account data for the user, those sites send preference sets, as indicated at 313, to advertising service 105. Preference sets comprise information provided by the user on his or her interests. As indicated at block 315, advertising service 105 uses information in the preference sets to determine products of interest to the user. Then, advertising service 105 sends the page requested at step 307 with information on products of interest determined at step 315 to user computer 109, as indicated at 317.

Thus, according to embodiments of the present invention, an advertising service is able to use information posted on social networking sites to determine a user's preferences and distilled products of interest that target those preferences. An E-commerce site identifies the user by e-mail address and encodes that e-mail address in URLs embedded in advertisements sent to the user. When the user requests information from an advertising service by clicking on one of the advertisements, the service decodes the e-mail address and the inquiry's different social networking services for profile information associated with the e-mail address. The social networking sites send this data back to the advertising service, which uses it to establish certain products of interest to service advertisements. These products of interest are then served as advertisements on the user's page.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of providing targeted advertising, which comprises:
receiving at an electronic commerce site a request from a user for a webpage;
determining an identifier for said user;
encoding said identifier with a universal resource locater (URL) associated with an advertisement;
embedding said advertisement in said first webpage; and,
sending said webpage from said electronic commerce site to said user.

2. The method as claimed in claim 1, wherein said identifier comprises an email address.

3. The method as claimed in claim 1, further comprising:
receiving said URL from said user at an advertising service; and,
sending a query from said advertising service to an information site, said query including said identifier.

4. The method as claimed in claim 2, further comprising:
receiving at said advertising service preference information for said user from said information site in response to query; and,
using said preference information to determine a product of interest to said user.

5. The method as claimed in claim 4, further comprising:
sending from said advertising service a second webpage to said user, said second webpage including information on said product of interest.

6. The method as claimed in claim 3, wherein said information site includes information provided by said user about said user.

7. The method as claimed in claim 6, wherein said information site is a social networking site.

8. The method as claimed in claim 1, further comprising:
sending from said advertising service queries to a plurality of social networking sites, each said query including said identifier.

9. The method as claimed in claim 8, further comprising:
receiving at said advertising service preference information for said user from at least one of said social networking sites in response to queries; and,
using said preference information to determine at least one product of interest to said user.

10. The method as claimed in claim 9, further comprising:
sending a webpage from said advertising service to said user, said webpage from said advertising service including information on said at least one product of interest.

11. The method as claimed in claim 9, further comprising:
using said preference information to determine a plurality of products of interest to said user; and,
sending from a webpage from said advertising service to said user, said webpage from said advertising service including information on at least some of said products of interest.

12. The method as claimed in claim 5, wherein said product of interest comprises goods.

13. The method as claimed in claim 5, wherein said product of interest comprises services.

14. An electronic commerce system, which comprises:
an electronic commerce site, said electronic commerce site comprising:
means for determining identifying information for a user;
means for encoding said identifying information in a request for product information;
means for embedding said request for product information in a webpage; and,
means for sending said webpage to said user.

15. The system as claimed in claim 14, wherein said request for product information comprises a uniform resource locater (URL).

16. The system, as claimed in claim 14, wherein said identifying information comprises an email address.

17. The system as claimed in claim 14, further comprising:
an advertising service, said advertising service comprising:
means for receiving said request for product information;
means for sending a query to a social networking site, said query including said identifying information.

18. The system as claimed in claim 17, wherein said advertising service further comprises:
means for determining products of interest based upon user preferences received from said social networking site in response to said query;
means for sending a webpage from said advertising service to said user, said webpage from said advertising service including said product information and information relating to said products of interest.

19. A method of providing targeted advertising, which comprises:
receiving at an electronic commerce site a request from a user for a webpage;
determining an identifier for said user;
encoding said identifier a universal resource locater (URL) associated with an advertisement;
embedding said advertisement in said first page;
sending said webpage from said electronic commerce site to said user;
receiving at an advertising service said URL from said user;
sending a query from said advertising service to a social networking site, said query including said identifier;
receiving at said advertising site preference information for said user from said social networking site in response to query;
using said preference information to determine products of interest to said user; and,
sending a webpage from said advertising site to said user, said webpage from said advertising service including information on said products of interest.

20. The method as claimed in claim 19, wherein said identifier comprises an email address.
